(19) United States
(12) Patent Application Publication
(10) Pub. No.: US 2010/0039884 A1
(43) Pub. Date: Feb. 18, 2010

(54) FUEL MIXING SYSTEM

(75) Inventors: Will Weathers, Charlotte, NC (US); Greg Blum, Charlotte, NC (US)

Correspondence Address: ADAMS INTELLECTUAL PROPERTY LAW, Suite 2350 Charlotte Plaza, 201 South College Street, CHARLOTTE, NC, 28244, US

(73) Assignee: SOUTHERN PUMP & TANK COMPANY, LLC, Charlotte, NC (US)

(21) Appl. No.: 12/392,234

(22) Filed: Feb. 25, 2009

Related U.S. Application Data
(60) Provisional application No. 61/088,439, filed on Aug. 13, 2008.

(51) Int. Cl. G05D 11/02

(52) U.S. Cl. 366/152.2

(57) ABSTRACT

A process for mixing separate fluid streams is provided. The process includes the steps of providing a first fluid stream and a second fluid stream having an adjustable flow rate and together forming an output stream, monitoring at least one predetermined characteristic of the output stream, and adjusting the flow rate of the second fluid stream according to a predetermined algorithm. The predetermined algorithm is dependent upon the at least one of the predetermined characteristics of the output stream.

### PRIORITY CLAIM

This application claims priority to Provisional Patent Application No. 61/088,439 filed on Aug. 13, 2008.

### TECHNICAL FIELD AND BACKGROUND OF THE INVENTION

This invention relates to a fuel mixing system for mixing biodiesel fuel within a diesel fuel mixture.

Biodiesel fuel is an increasingly important fuel source because of environmental, cost, and supply concerns. Biodiesel is produced by mixing biological fuel sources with a petroleum fuel source. Diesel fuel is a refined petroleum fuel source that is burned in engines powering most of the world's trains, ships, and large trucks. Petroleum is a non-renewable resource of finite supply. Acute shortages and dramatic price increases in petroleum and the refined products derived from petroleum have been adversely affected by industrialized countries during the past quarter-century. Further, many engines, particularly diesel engines, emit relatively high levels of certain pollutants, especially particulates. Governments have provided increased regulation of pollutants exhausted into the air from the combustion of diesel fuel. Accordingly, extensive research efforts are now being directed toward replacing some or all petroleum-based diesel fuel with a cleaner-burning fuel derived from a renewable source such as farm crops.

Vegetable oils produced from farm crops have been directly added to diesel fuel in an attempt to replace at least a portion of the diesel fuel. These vegetable oils contain a large amount of esters that are desirable for fuel mixing purposes. Significant quantities of esters such as triglycerides and free fatty acids are available from inexpensive feedstocks such as, animal fats, vegetable oils, rendered fats, restaurant grease and waste industrial frying oils. The triglyceride esters can be reacted, or transesterified, with alcohol to produce glycerol and the alkyl esters, and the free fatty acid can be reacted, or esterified, with alcohol or water to produce the alkyl ester. These alkyl esters create desirable additives or alternatives to petroleum diesel fuel as well as other high value end products such as detergent surfactants, herbicides, pesticide diluents, sticking agents, or lubricating additives for hydraulic and transmission fluids to name a few. For all of these reasons, biodiesel has become an increasingly popular fuel choice and demand for biodiesel is certain to increase.

Blends of biodiesel and conventional petroleum based diesel are products most commonly distributed for use in the retail diesel fuel marketplace. Most of the world employs a naming system known as the “B” factor to state the amount of biodiesel in any fuel mix. For example, fuel containing 20% biodiesel is labeled B20. B20 blends can generally be used in unmodified diesel engines. Use of biodiesel in its pure form B100 may require certain engine modifications to avoid maintenance and performance problems.

Biodiesel is produced by mixing regular diesel with an organic fuel source. Conventional biodiesel mixing systems have employed a variety of methods in order to mix biodiesel within a diesel fuel mixture. Such methods have included splash blending and inline injection blending. Splash blending is a process where diesel and biodiesel are simultaneously pumped into a large tank and then transported to a fueling location for sale. Under this process, the biodiesel and diesel are blended by agitation during transport to a retail or distribution site. This process is relatively cost efficient but is also subject to many disadvantages, including insufficient emulsion and fraud. Insufficient emulsion occurs because of varying densities between the organic fuel source and the diesel fuel source. Fraud occurs when biodiesel is not pumped with the regular diesel because of biodiesel's current relatively high cost. Inline injection blending is more costly than splash blending but offers better emulsion results. Inline injection blending adds biodiesel into a stream of diesel as it travels through a production facility. This results in increased emulsion over splash blending and is better regulated forfraud purposes. However, inline injection blending is accomplished by adding biodiesel to the diesel stream in small slugs or pulses. As the diesel flow rate changes due to variations in pressure or density, the addition of biodiesel slugs may not be in appropriate proportions or fully mixed within the diesel fuel. This can adversely affect vehicle performance when the fuel is used to power a vehicle.

Accordingly, a need remains for an improved biodiesel mixing system that is cost effective and appropriately mixes fuels.

### SUMMARY OF THE INVENTION

Therefore it is an object of the invention to provide an inline biodiesel mixer.

It is another object of the invention to provide an inline biodiesel mixer having a flow stream of diesel fuel for mixing with a stream of biodiesel fuel.

It is another object of the invention to provide a monitoring system for monitoring the mixing rate of biodiesel within a diesel fuel stream of an inline biodiesel mixture.

It is another object of the invention to provide a control system having an algorithm to control the mixing rate of biodiesel within a diesel fuel stream of an inline biodiesel mixer.

These and other objects of the present invention are achieved in the preferred embodiments disclosed below by providing a process for mixing separate fluid streams. The process comprises the steps of providing a first fluid stream and a second fluid stream having an adjustable flow rate and together forming an output stream, monitoring at least one predetermined characteristic of the output stream, and adjusting the flow rate of the second fluid stream according to a predetermined algorithm, wherein the predetermined algorithm is dependent upon the at least one of the predetermined characteristics of the output stream.

According to another embodiment of the present invention, the first fluid stream is a flow of biodiesel.

According to another embodiment of the present invention, the second fluid stream is a flow of petroleum based diesel.

According to another embodiment of the present invention, the predetermined characteristic is the ratio of the volume of the first fluid stream and the second fluid stream.

According to another embodiment of the present invention, the first fluid stream has a volume flow rate dependent upon the second fluid stream according to a desired ratio.

According to another embodiment of the present invention, the algorithm is a proportional-integral-derivative that monitors the actual ratio of the volume of the first fluid stream and the second fluid stream and compares the actual ratio to the desired ratio, and adjusts the second fluid stream output according to an open loop controller so that the actual ratio approximates the desired ratio.

According to another preferred embodiment of the present invention, a process for mixing separate fluid streams is provided and includes the steps of providing a first fluid stream α and a second fluid stream β having a flow rate adjustable by a pump having a control variable θ controlled by a proportional-integral-derivative controller, wherein the first fluid stream α and the second fluid stream β form an output stream κ and the second fluid stream β is initially determined by an equation of the form:

$$( β ) = α * \frac{Ψ}{1 - Ψ}$$

wherein ψ is equal to the desired ratio of β/(α+β), monitoring the actual ratio of the output stream, wherein the actual ratio is determined by an equation of the form:

$$( X ) = \frac{β}{κ}$$

wherein X is the actual ratio, adjusting the flow rate of the second fluid stream β according to the proportional-integral-derivative controller, wherein the proportional-integral-derivative controller compares the actual ratio X to the desired ratio ψ and determines the appropriate control variable θ and then outputs the control variable θ to the second fluid stream β, thereby adjusting the flow rate of the second fluid stream β.

According to another embodiment of the present invention, a control system for monitoring the flow of a first fluid stream and a second fluid stream forming one output stream according to a desired ratio between the first fluid stream and the second fluid stream includes a proportional-integral-derivative controller configured to monitor the actual ratio of the volume of the first fluid stream and the second fluid stream in the output stream, compare the actual ratio to the desired ratio, and adjust the flow rate of either the first fluid stream or the second fluid stream depending on the difference between the actual ratio and the desired ratio.

According to another embodiment of the present invention, an inline biodiesel mixer is provided. The inline biodiesel mixer includes a variable flow diesel path, a variable flow biodiesel path connected with the diesel flow path and forming a blend fuel path, a monitoring system configured to monitor the mixing rate of the diesel path and biodiesel path, and a controller system designed to vary the variable flow diesel path and the variable flow biodiesel path in order to provide appropriate mixtures of the blend fuel path.

According to another embodiment, the variable flow biodiesel path flows within a biodiesel pipe having an inlet connected with a biodiesel source.

According to another embodiment, the biodiesel flow path is varied by a variable output biodiesel pump located within the biodiesel pipe and in communication with the controller system.

According to another embodiment, the variable diesel flow path flows within a diesel pipe having an inlet connected with a diesel source

According to another embodiment, the biodiesel flow path is varied by a variable output diesel pump located within the biodiesel pipe and in communication with the controller system.

According to another embodiment, the diesel flow path is measured by a diesel flow meter located within the diesel flow pipe and in communication with the controller system.

According to another embodiment, the monitoring system is in communication with the control system and the control system has an algorithm designed to adjust output of the variable output biodiesel pump in relation to varying flows.

According to another embodiment, the control system includes an algorithm designed to adjust output of the variable output diesel pump in relation to varying flows.

According to another embodiment, the control system includes an algorithm designed to adjust output of the variable output biodiesel pump in relation to varying flows.

According to another embodiment, the mixer includes a strainer

According to another embodiment, the mixer includes a cut off switch

According to another embodiment, the mixer includes a cutoff valve

According to another embodiment, the mixer includes a pressure gage

According to another embodiment, the mixer includes a bypass flow path connected with at least one of the biodiesel or diesel paths for bypassing the diesel flow meter or the variable output biodiesel pump.

According to another embodiment, the mixer includes a pressure gage connected with at least one of the biodiesel, diesel flow paths or blend fuel path.

According to another embodiment, a process for mixing biodiesel fuel is provided. The process involves the steps of providing a biodiesel path regulated by a variable output biodiesel pump, a diesel path regulated by a diesel flow meter, and a blend path formed by the fluid connection of the diesel and biodiesel path. A control system is in communication with a monitoring system that monitors the ratio of flow of the biodiesel and diesel paths. The control system is configured to variably output the rate of flow of the biodiesel and diesel paths and provide optimum efficiency.

According to another embodiment, a biodiesel mixer is provided. The biodiesel mixer includes a diesel flow path, a biodiesel flow path, a mixed fuel path formed by the fluid connection of the diesel flow path and the biodiesel flow path, and a monitoring system configured to monitor outputs from at least one of the diesel flow path, the biodiesel flow path, and the mixed fuel path. A control system is in communication with the monitoring system and configured to variate the output of at least one of the diesel flow path, the biodiesel flow path, and the mixed flow path, so that an optimum and desired mixed flow path may be achieved.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a perspective view of a biodiesel mixer according to an embodiment of the invention;

FIG. 2 is a top view of a biodiesel mixer according to an embodiment of the invention;

FIG. 3 is a right side view of a diesel flow system relative to FIG. 2 according to an embodiment of the invention;

FIG. 4 is a left side view of a biodiesel flow system relative to FIG. 2 according to an embodiment of the invention; and

FIG. 5 is a schematic view of the control system for monitoring fluid flow according to an embodiment of the invention.

### DESCRIPTION OF THE PREFERRED EMBODIMENTS AND BEST MODE

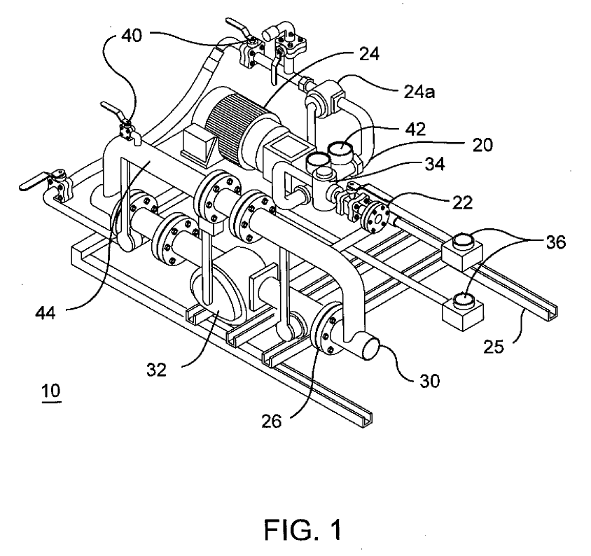

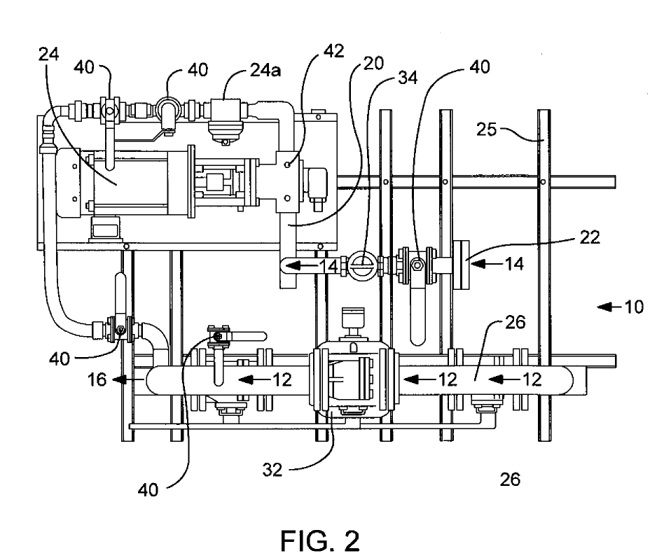

Referring now specifically to the drawings where like elements are represented by like referenced numerals, a biodiesel mixer according to the present invention is provided and shown in FIGS. 1-4 and generally designated 10. The biodiesel mixer 10 is part of a process for monitoring the mixing ratios of two separate fluid streams, and more particularly, for mixing biodiesel and petro diesel fuel streams. The mixer 10 includes a variable flow diesel path 12 and a variable flow biodiesel path 14 fluidly connected with one another. The diesel path 12 and biodiesel path 14 are mixed to form a blend path 16. The blend path 16 contains the mixed diesel and biodiesel fuels and is mixed in such a manner as to be suitable for automotive or other appropriate uses. A junction box 36 is provided for making field wiring connections to the mixer 10.

The diesel fuel path 12 flows within the diesel pipe 26. A valve 40 may be provided within the diesel fuel path 12 and may be used to siphon, cutoff, fluid bleeding, or other desired reasons. In some instances, the diesel fuel path 12 further includes a diesel flow meter 32 configured to pump diesel fuel and in some instances, is a variable output pump.

The biodiesel fuel path 14 includes an inlet 22 connected with a biodiesel source. The biodiesel flow path 14 includes a biodiesel flow pump 24 configured to pump biodiesel fuel and in some instances is a variable output pump. The biodiesel fuel path 14 flows within the biodiesel pipe 20. A strainer 34 may be provided within the biodiesel fuel path 14 and/or within the diesel fuel path 14. A valve 40 may also be provided within the biodiesel fuel path 14 as discussed in regards to the diesel fuel path 14. A biodiesel flow meter 24a is provided within the biodiesel fuel path 14. A variety of other gages 42 may be included for monitoring pressure, temperature, or other desired variables.

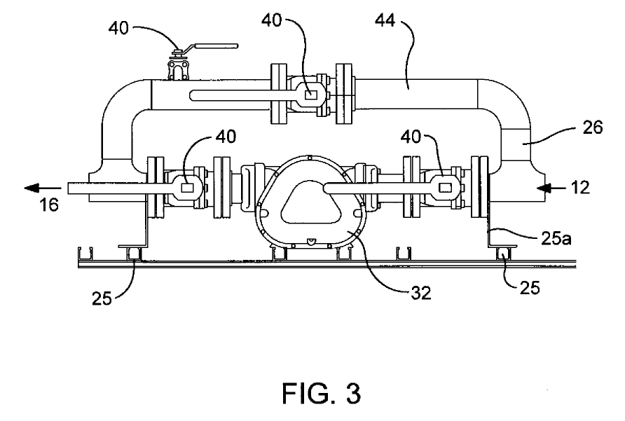

As shown in FIG. 3, a bypass 44 is provided to bypass the diesel flow meter 32 if needed. The diesel fuel path 12 may be controlled by a variety of cut off valves 40. As shown in this embodiment, a stand 25 is provided to support the mixer and further includes longitudinal supports 25a. The pipe 20 is made of any suitable material, shape, or size.

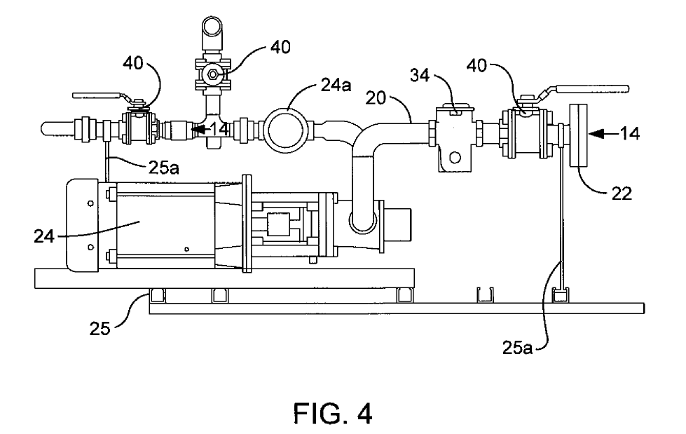

As shown in FIG. 4, the biodiesel fuel path 14 enters through a first elbow formed within the biodiesel pipe 20. The biodiesel may go through a strainer 34 before entering the biodiesel flow pump 24. After entering the biodiesel flow pump 24, the biodiesel fuel flows through the biodiesel pipe 20 into a second elbow. The biodiesel flow meter 24a is positioned downstream of the biodiesel flow pump 24. The biodiesel flow path 14 is then mixed with the diesel flow path 12 to form the blend path 16. A hose or any suitable connection is used to connect the two paths. In some instances, it may be desirable to only have a variable output pump within one fuel path and adjust the other path as desired.

A control system monitors the blend path 16 and the actual gallons of consumption in the diesel flow path 12 and the biodiesel flow path 14. The control system is able to control the flow rate within either the diesel flow path 12 or the biodiesel flow path 14 to reach preferred mixing ratios in the blend path 16. The operation of the control system is described in subsequent paragraphs.

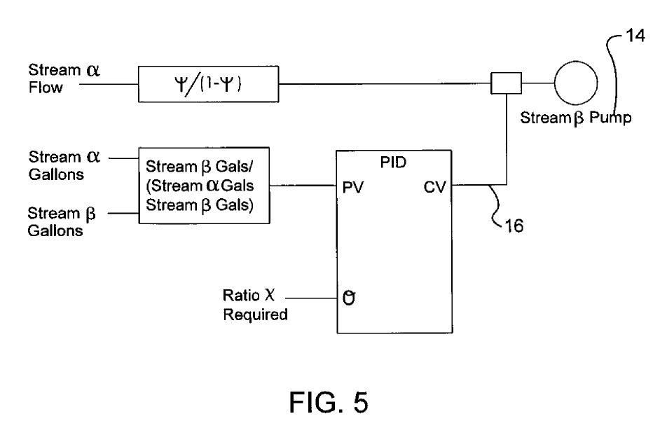

A schematic diagram of the process of the present invention is shown in FIG. 5. Stream α represents the main fluid stream, in this instance diesel flow path 12. Stream β represents the biodiesel fluid stream, flow path 14. The total output stream κ is represented by blend path 16 in FIGS. 1-4. For startup purposes, stream a flow is multiplied by a factor of the desired ratio (ψ)/(1−desired ratio (ψ)), where ψ is equal to (stream β)/(stream α+stream β). As a non-limiting example, for a B20 fuel mixture, stream β would then equal 20% and stream a would equal 80%, giving a ratio (ψ) equal to (20)/(20+80)=0.20. Stream β flow would them equal stream a flow times (ψ)/(1−ψ), or 0.2/(1−0.2), giving stream p flow equal to 0.25 times stream a flow. These numbers are then scaled based on the expected flow rates. For example, if stream a was to have a flow rate of 100 gals/min, then stream p flow would be equal to (0.25)(100 gal/min)=25 gal/min.

Once the pump 24 starts to run, a running total of gallons is kept for stream α and stream β. These numbers are then used to calculate the actual ratio (X) which equals (stream β gallons)/(stream α gallons+stream β gallons). The PID algorithm then monitors the control variable to adjust ratio ψ to determine the error between desired ratio ψ and actual ratio X. This is done by the PID equation, which sums up the proportional, integral, and derivative terms, to reach output θ, which adjusts the flow rate of stream β within the PID open loop. The open loop continues to monitor the flow rates during the process, and works to maintain actual ratio X within acceptable ranges of desired ratio ψ. In this way, the instantaneous flow ratio is addressed as well as the batch total ratio.

While the foregoing has described a biodiesel fuel mixing system, the embodiments and principles set forth in this application may be utilized in a variety of other mixing systems. Furthermore, additional fluid flow paths may be utilized and added to the system. For example, it may be desirable to mix ethanol, alcohol, cooking oil, gasoline, and a variety of other fluids. In these embodiments, a monitoring system and a control system would be in communication with additional lines and configured appropriately.

1. A process for mixing separate fluid streams, comprising the steps of:
providing a first fluid stream and a second fluid stream having an adjustable flow rate and together forming an output stream;
monitoring at least one predetermined characteristic of the output stream; and
adjusting the flow rate of the second fluid stream according to a predetermined algorithm, wherein the predetermined algorithm is dependent upon the at least one of the predetermined characteristics of the output stream.

2. The process according to claim 1, wherein the first fluid stream is a flow of biodiesel.

3. The process according to claim 1, wherein the second fluid stream is a flow of petroleum based diesel.

4. The process according to claim 1, wherein the predetermined characteristic is the ratio of the volume of the first fluid stream and the second fluid stream.

5. The process according to claim 1, wherein the first fluid stream has a volume flow rate dependent upon the second fluid stream according to a desired ratio.

6. The process according to claim 5, wherein the algorithm is a proportional-integral-derivative that monitors the actual ratio of the volume of the first fluid stream and the second fluid stream and compares the actual ratio to the desired ratio, and adjusts the second fluid stream output according to an open loop controller so that the actual ratio approximates the desired ratio.

7. A process for mixing separate fluid streams, comprising the steps of:
providing a first fluid stream α and a second fluid stream β having a flow rate adjustable by a pump having a control variable θ controlled by a proportional-integral-derivative controller, wherein the first fluid stream α and the second fluid stream β form an output stream κ and the second fluid stream β is initially determined by an equation of the form:
$$( β ) = α * \frac{Ψ}{1 - Ψ}$$
wherein ψ is equal to the desired ratio of β/(α+β);
monitoring the actual ratio of the output stream, wherein the actual ratio is determined by an equation of the form:
$$( X ) = \frac{β}{κ}$$
wherein X is the actual ratio;
adjusting the flow rate of the second fluid stream β according to the proportional-integral-derivative controller, wherein the proportional-integral-derivative controller compares the actual ratio X to the desired ratio ψ and determines the appropriate control variable θ and then outputs the control variable θ to the second fluid stream β, thereby adjusting the flow rate of the second fluid stream β.

8. A control system for monitoring the flow of a first fluid stream and a second fluid stream forming one output stream according to a desired ratio between the first fluid stream and the second fluid stream, the control system comprising a proportional-integral-derivative controller configured to monitor the actual ratio of the volume of the first fluid stream and the second fluid stream in the output stream, compare the actual ratio to the desired ratio, and adjust the flow rate of either the first fluid stream or the second fluid stream depending on the difference between the actual ratio and the desired ratio.
